(19) United States
(12) Patent Application Publication
(10) Pub. No.: US 2008/0084030 A1
(43) Pub. Date: Apr. 10, 2008

(54) Segmented air floating seal

(75) Inventor: Jack W. Wilson JR., Palm Beach Gardens, FL (US)

Correspondence Address: John Ryznic;Florida Turbine Technologies, Inc., Suite 110, 1701 Military Trail, Jupiter, FL, 33458-7887, US

(73) Assignee: Florida Turbine Technologies, Inc., Jupiter, FL (US)

(21) Appl. No.: 11/998,368

(22) Filed: Nov. 29, 2007

Related U.S. Application Data
(63) Continuation-in-part of application No. 11/183,275, filed on Jul. 15, 2005, now abandoned.
(60) Provisional application No. 60/677,896, filed on May 5, 2005.

(51) Int. Cl. F16J 15/40

(52) U.S. Cl. 277/409

(57) ABSTRACT

A segmented floating seal assembly used in a gas turbine engine to seal a rotary shaft. The segmented seal is made from a fiber reinforced ceramic matrix composite (FRCMC) material having a polymer-derived pre-ceramic resin in its ceramic state, fibers of Nextel, and a filler material. The seal segments are secured to respective support plates, and the support plates are each biased by a spring member secured to a support ring mounted in the engine. The material in the seal segments are resistive to very high temperatures, are not brittle, allow little flow across the seal face, and durable. The segmented seal includes holes in either the segments or the rotary shaft in which pressurized air is supplied to the seal interface to form an air cushion on which the seal segments can float.

### CROSS-REFERENCE TO RELATED APPLICATION

This application is a Continuation In Part of U.S. Regular patent application Ser. No. 11/183,275 filed Jul. 15, 2005; and which claims the benefit to U.S. Provisional Application No. 60/677,896 filed on May 5, 2005.

### BACKGROUND OF THE INVENTION

1. Field of the Invention

The present invention relates to a floating seal in a gas turbine engine, and more specifically to a segmented, floating seal made of a heat resistant fiber reinforced ceramic matrix material such as Nextel fiber.

2. Description of the Related Prior Art Including Information Disclosed Under 37 CFR 1.97 and 1.98.

Gas turbine engines operate under very high temperatures, temperatures that approach a melting point of the materials used in the turbine. Labyrinth seals are well known for use in high temperature environments because they can withstand these extreme temperatures. However, a labyrinth seal does not provide a good seal in that a significant amount of fluid passes across this seal interface.

Contact (or, face) seals are well known seals that allows very little flow across the face. However, face seals make contact against a rotating face and thus are limited to the rotational speed in which they are used. Also, contact seals are not used in high temperature environments.

Laminated finger seals are known in the art as exemplified by U.S. Pat. No. 5,108,116 issued to Johnson et al on Apr. 28, 1992. These seals are designed for fluid sealing between relatively rotating elements as for example a shaft and housing. As a result of this application, the fingers, which may have a foot element, are designed to slide on the shaft element when rotating. The finger portion provides pressure through the foot portion to maintain contact with the rotating shaft. A balance must be maintained to avoid excessive wear of the foot portion and the rotating shaft. There exist various improvements in designs for the foot portion, as for example to give it aerodynamic properties to glide over the surface of the shaft. In such an application, a considerable amount of pressure can be exerted by the finger elements to maintain a tight seal interface, and aerodynamic or sliding motion at low friction levels is not required. However, the use of a ceramic composition as in the Johnson invention includes a ceramic finger seal that can withstand the excessive heat generation caused by the friction between the seal and the rotating shaft.

A ceramic floating seal is disclosed in U.S. Pat. No. 6,736,401, issued to Chung et al on May 18, 2004 and discloses a ceramic finger seal for use between housing and a combustor liner to inhibit air passage there-between, and for use in fluid sealing between a rotating shaft and a housing circumscribing the rotating shaft. The ceramic finger seal has at least two annular diaphragm members constructed of two or more diaphragm segments bonded end to end by ceramic cement or other high temperature joining compounds. The diaphragm members may be partitioned into a generally continuous inner diameter portion and a segmented outer diameter portion or the reverse thereof. The segmented portion includes finger elements spaced uniformly apart forming gaps there between and extend radially outward or inward terminating in a foot portion. The rolled edge on the finger is formed by laser cutting to prevent gouging of the combustor liner surface.

A floating seal is disclosed in U.S. Pat. No. 4,453,721 issued to Angus et al on Jun. 12, 1984. Two seal elements are respectively mounted on generally coaxial relatively rotatable members so that each seal element is capable of relative radial movement with respect to its associated member. One of the seal elements is mounted on its associated member in such a manner that they remain coaxial. The seal elements have confronting radially spaced apart surfaces which are so configured that together they define a hydrodynamic gas bearing. The arrangement is such that upon the relative rotation of the members said seal element which is mounted so as to remain coaxial with its associated member hydrodynamically supports the other seal element so that they remain coaxial.

The U.S. Pat. No. 5,558,341 issued to McNickle et al on Sep. 24, 1996 and entitled SEAL FOR SEALING AN INCOMPRESSIBLE FLUID BETWEEN A RELATIVELY STATIONARY SEAL AND A MOVABLE MEMBER shows a Garter Spring used in a high pressure sealing environment in which the seal is made of segments that are compressed in a radial inward direction by a garter spring against the outer shaft surface. Because of the garter spring, the seal segments are constantly rubbing against the shaft surface with a high enough force to generate a lot of heat. Also, because of the rubbing the seal segments wear rather fast and must be replaced often. In a situation such as the present invention, this type of seal segment would generate too much eat to be of use. Also, the short life time for the seal segments due to the constant rubbing would not be acceptable for use in the industrial gas turbine engine because of the necessary long operating time for the engine before a shutdown occurs. Thus, the segmented seal must be capable of operating in high temperatures and operate for long periods of time without degrading the seal capability.

A high temperature resistant material is disclosed in the Strasser U.S. Pat. No. 6,062,351 issued in May 16, 2000 used in a brake pad. An integrated brake pad and back plate having a brake pad section formed from a first fiber reinforced ceramic matrix composite (FRCMC) material and a back plate section formed from a second FRCMC material. The brake pad and back plate are integrated because the sections are molded together to form an integral, unitary structure. The first FRCMC material used in the brake pad section includes a pre-ceramic resin in its ceramic state, fibers and possibly a filler material. The types and amount of these constituents are generally chosen so as to impart characteristics desirable in brake pads, such as high temperature and erosion resistance, and a high coefficient of friction. The second FRCMC material used in the back plate section includes a pre-ceramic resin in its ceramic state and fibers. In this case, the types and amounts of the constituents making up the second FRCMC material are generally chosen to impart the strength to the back plate section necessary to withstand compressive and bending forces placed upon it during braking. The preferred fibers are at least one of alumina, Nextel 312, Nextel 440, Nextel 510, Nextel 550, silicon nitride, silicon carbide, HPZ, graphite, carbon, and peat.

In the ceramic seal disclosed in the Johnson and Chung patents, the seal face, the fingers, and the support structure for the fingers are all made of the ceramic material, which is a brittle material. Also, the seal assembly is formed of a series of stacked plates such that gaps between adjacent fingers are covered up by an adjacent plate to prevent fluid leakage between fingers. This seal is both costly to make and not very durable in use.

Thus, there is a need for a high temperature seal that provide both very low flows across the seal interface and is capable of use under extreme high temperatures.

In addition, there is a need for a high temperature seal that is both lower in cost and longer lasting.

### BRIEF SUMMARY OF THE INVENTION

The object of the present invention is to provide a high temperature seal with low leakage (or flow) across the seal interface.

It is another object of the present invention to provide a high temperature seal that is also durable.

It is another object of the present invention to provide for an air floating seal that is easier to replace the seal part than in the cited prior art references.

This objective is accomplished by providing a segmented floating seal assembly in which the seal material is made from a fiber reinforced ceramic matrix composite (FRCMC) material using fibers such as Nextel for resistance to extreme high temperatures. The annular seal is segmented in order to allow the seal to vary in circumference. When the seal surface is not rotating with respect to the seal face, the seal face is in contact with the seal surface. When the seal surface is rotating with respect to the seal face above a certain speed, the seal circumferential increases due to an air cushion formed between the face and surface producing the floating seal. The seal face is made of the FRCMC—which is a brittle material—but is mounted on a support structure like a steel plate that is very durable. The support plate carrying the FRCMC material is suspended by a metallic spring or finger extending from a main support structure to allow for the seal assembly to expand when the seal interface develops a fluid film or cushion do to the relative velocity between the face of the seal and the surface on which the seal makes contact. The face of each seal segment can include a hard face coating, since the surface of the Nextel fiber material can be somewhat rough. Any well-known hard face coating will work, but a preferable coating would be T800.

In another embodiment of the present invention, one or more of the seal segments include radial holes in which pressurized air is delivered to the seal interface to produce a film layer to aid in producing the floating seal.

In still another embodiment of the present invention, the radial holes provided for the film layer of air is formed in the rotating shaft.

### BRIEF DESCRIPTION OF THE SEVERAL VIEWS OF THE DRAWINGS

FIG. 1 shows the segmented floating seal assembly of the present invention.

FIG. 2 shows a top view of two adjacent seal segments with a stepped interface.

FIG. 3 shows a second embodiment of the stepped interface between adjacent segments.

FIG. 4 shows a seal segment and a shaft face with a cushion of air formed between the two faces.

FIG. 5 shows a third embodiment of the segmented seal of the present invention with radial air holes in the segments.

FIG. 6 shows a fourth embodiment of the segmented seal of the present invention with the radial air holes in the rotating shaft instead of the segments.

### DETAILED DESCRIPTION OF THE INVENTION

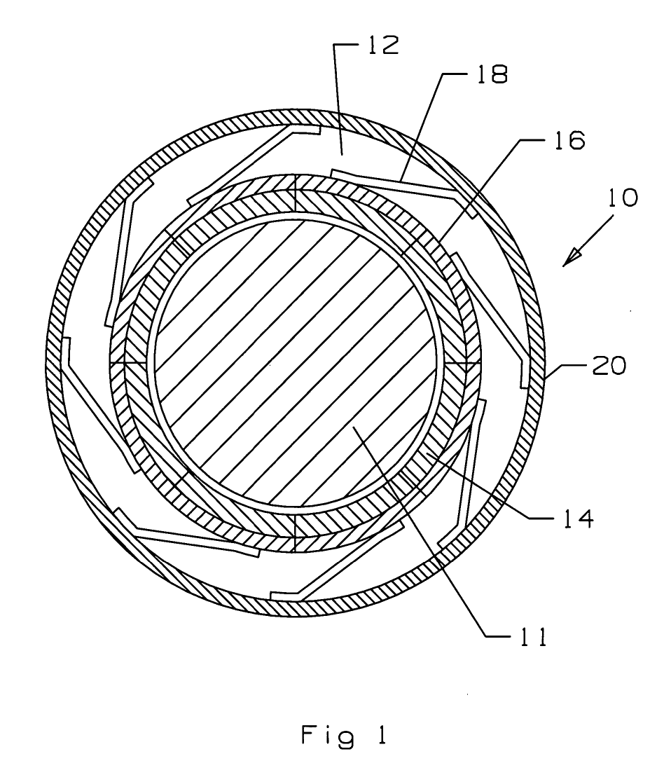

The present invention is a high temperature floating seal used in a gas turbine engine as best seen in FIG. 1. The seal assembly 10 is formed of a plurality of seal segments 12 arranged in an annular shape around a rotational shaft 11. In the FIG. 1 embodiment, there are 8 segments of equal size. Each seal segment includes a seal face 14 made from a material resistant to extremely high temperatures. In the instant invention, the seal face segments are formed of a fiber reinforced ceramic matrix composite (FRCMC) material using fibers such as Nextel. This material is described in U.S. Pat. No. 6,062,351 issued to Strasser et al; U.S. Pat. No. 5,806,636 issued to Atmur et al, U.S. Pat. No. 6,153,291 issued to Strasser; and U.S. Pat. No. 6,231,793 issued to Strasser et al, each of which is incorporated herein by reference.

The seal face segments 14 are each secured to a metal support plate 16. The support plate provides a rigid support for the brittle ceramic material. The support plate eliminates the need to form the entire seal assembly from the same brittle ceramic material used in the seal of the Johnson and Chung inventions disclosed above. Thus, the seal assembly of the present invention can be used under higher loads and longer life. The inside surface of each segment facing the sealing surface is coated with a hard fact coating such as T800. Any well-known hard face coating can be used.

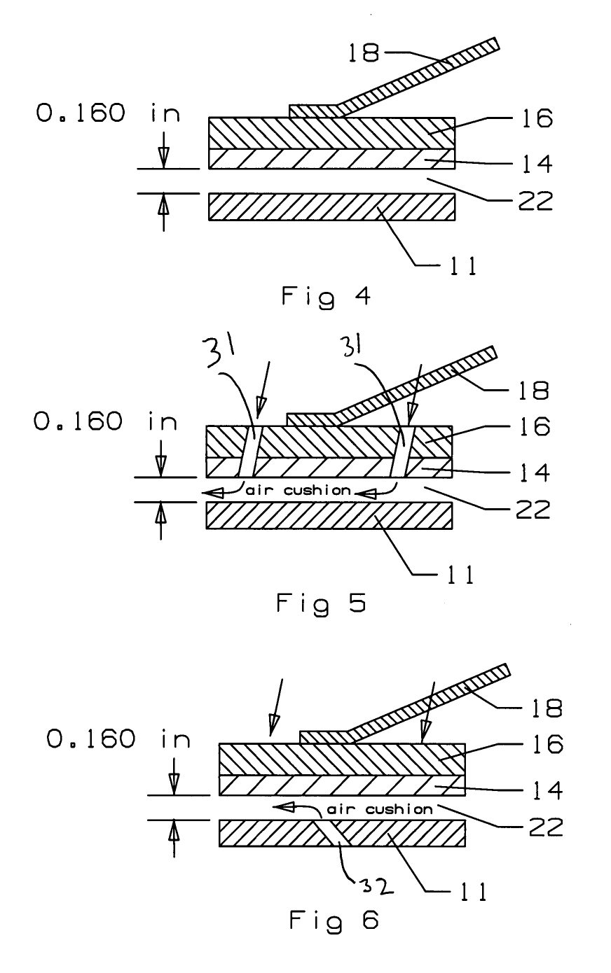

Each support plate includes a metal spring or finger 18 to hold the seal face in place, but also to allow for the seal face to move away from the shaft 11 surface during rotation of the shaft. Each metal spring or finger 18 is secured to a support ring 20. The support ring mounts to a portion of the gas turbine to secure the seal assembly in place around the shaft. When the shaft is not rotating, the seal segments are in contact with the shaft surface. When the shaft rotates above a certain speed, a film cushion of air 22 (FIG. 4) is developed between the seal surface 14 and the shaft surface 11. Thus, a floating seal is formed. This effect is described in U.S. Pat. No. 4,331,337 issued to Cross et al, U.S. Pat. No. 5,108,116 issued to Johnson et al, and U.S. Pat. No. 4,453,721 issued to Angus et al, each of which is incorporated herein by reference.

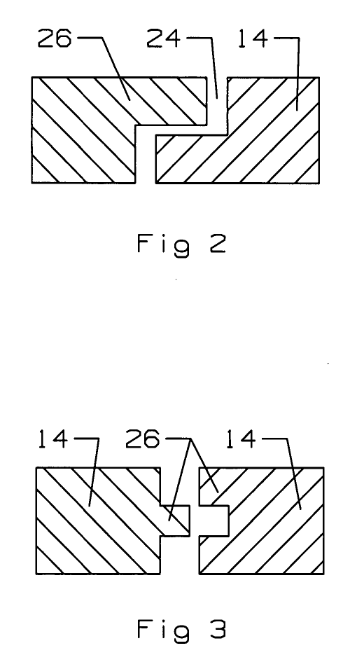

Since the seal is a floating seal, the seal must be formed in segments to allow the circumference of the seal face to increase. As the circumference increases, the gap 24 (FIG. 4) between adjacent segments also increases. This gap will allow fluid to bypass the seal face. In order to significantly reduce this bypass through the gap, the ends of the segments each have a step formation 26. FIG. 2 shows the top view, or outer surface view, of the seal segments. Other shapes for the segment ends can be used to eliminate the gap formed between adjacent segments due to the circumferential growth of the seal. Many shapes are well known in the art of piston rings or seal rings.

A second embodiment of the stepped shape ends of the segments are shown in FIG. 3. This embodiment provides an additional degree of constraint over that shown in FIG. 2. The stepped ends in FIG. 3 will prevent the adjacent seal segments from moving against with respect to each other along the axial direction parallel to the shaft. Other shapes can be used on the segment ends to prevent a gap between adjacent segments. Many are well known in the art of piston rings or seal rings.

FIG. 4 shows a single seal segment with the ceramic seal face 14 secured on to the metal support plate 16, and the metal spring 18 secured to a top surface of the support plate 16. The metal spring is of such thickness that the seal segment 14 and plate 16 are biased against the shaft 11 when the rotation of the shaft is below the necessary speed to produce the air cushion. The air cushion lifts the seal face off of the shaft, producing the floating seal effect. Because the seal face is not in contact with the rotating shaft surface, the seal can be used in high rotational speed environments without overheating. Also, a floating seal does not wear out as fast as a normal contact seal, therefore increasing the lifetime of the seal.

FIG. 5 shows an embodiment of the segmented seal assembly of the present invention in which one or more radial holes 31 are formed in one or more of the seal segments to direct compressed air into the space 22 formed between the rotating shaft 11 and the seal segments 14 to produce a film layer for the air cushion on which the seal segments ride during rotation of the shaft 11. The seal segment 16 can have one or more holes 31 to supply the compressed air. Also, more than one seal segment 16 can include one or more holes 31 to provide for the air film that produces the air cushion effect. The radial holes 31 can be normal to the seal surface or offset at an angle to improve the film layer for the air cushion.

FIG. 6 shows a variation of the embodiment in FIG. 5 in which the air holes 32 for the film layer are provided within the rotary shaft 11 instead of the seal segments 16. The pressurized air is delivered through the shaft and forms the film layer between the shaft surface and the seal segments o produce the air cushion. The numbers of holes 32 can vary depending upon the air flow to produce the air cushion in the seal interface.

The present invention shows a floating seal for use in a gas turbine engine. However, the present invention can be used in machines other than gas turbines. Any machine that requires a high temperature seal or a high rotational speed seal would benefit from the seal disclosed in this invention.

I claim the following:

1. A segmented air floating seal assembly to provide a seal against a rotary shaft, comprising:
a support ring secured to a stationary part;
a plurality of spring bias members each connected to the support ring;
a plurality of arc shaped support plates, each support plate being connected to a respective spring bias member;
a plurality of arc shaped seal segments, each seal segment being connected to a respective support plate, each seal segment having a curved seal face of substantially the same radius as the rotary shaft;
the seal segments being made of a fiber reinforced ceramic matrix composite material; and,
wherein the spring segments provide a bias to the seal segments and an air cushion is developed during rotation such that the segments float on the rotary shaft without touching.

2. The segmented air floating seal assembly of claim 1, and further comprising:
The fiber reinforced ceramic matrix composite material includes a pre-ceramic resin in its ceramic state, and fibers.

3. The segmented air floating seal assembly of claim 2, and further comprising:
the pre-ceramic resin is a polymer-derived pre-ceramic resin.

4. The segmented air floating seal assembly of claim 3, and further comprising:
the polymer-derived pre-ceramic resin is one of silicon-carboxyl resin and alumina silicate resin.

5. The segmented air floating seal assembly of claim 1, and further comprising:
The fibers are comprised of one or more of alumina, Nextel 312, Nextel 440, Nextel 510, Nextel 550, silicon nitride, silicon carbide, HPZ, graphite, carbon, and peat.

6. The segmented air floating seal assembly of claim 5, and further comprising:
The fibers being in the form of non-continuous, loose fibers having lengths of about 0.2 to 5.0 inches.

7. The segmented air floating seal assembly of claim 6, and further comprising:
The fibers comprise a volume percent of about 15 to 60 percent

8. The segmented air floating seal assembly of claim 1, and further comprising:
The seal segments also being made of a filler material, the filler material comprising one of alumina, mullite, silica, silicon carbide, titania, silicon nitride, boron nitride, carbon, magnesium oxide, and boron carbide.

9. The segmented air floating seal assembly of claim 8, and further comprising:
The filler material comprises a volume percent of about 0 to 50 percent.

10. The segmented air floating seal assembly of claim 4, and further comprising:
The fibers are comprised of one or more of alumina, Nextel 312, Nextel 440, Nextel 510, Nextel 550, silicon nitride, silicon carbide, HPZ, graphite, carbon, and peat.

11. The segmented air floating seal assembly of claim 10, and further comprising:
The fibers being in the form of non-continuous, loose fibers having lengths of about 0.2 to 5.0 inches.

12. The segmented air floating seal assembly of claim 11, and further comprising:
The fibers comprise a volume percent of about 15 to 60 percent

13. The segmented air floating seal assembly of claim 12, and further comprising:
The seal segments also being made of a filler material, the filler material comprising one of alumina, mullite, silica, silicon carbide, titania, silicon nitride, boron nitride, carbon, magnesium oxide, and boron carbide.

14. The segmented air floating seal assembly of claim 1, and further comprising:
At least one air supply hole in either the seal segment or the rotary shaft to supply a cushion of air to the seal interface between the seal face and the rotary shaft.

15. The segmented air floating seal assembly of claim 1, and further comprising:
adjacent seal segments have a step formation to allow for expansion of the seal segments without opening a gap between segments for leakage to flow.

16. The segmented air floating seal assembly of claim 15, and further comprising:
The step formation is a tongue extending from one segment into a groove formed on the adjacent segment.

17. The segmented air floating seal assembly of claim 11, and further comprising:
There are from four to eight seal segments to form a complete annular segmented seal.

18. A segmented air floating seal assembly to provide a seal against a rotary shaft, comprising:
a support ring;
a plurality of bias members each connected to the support ring;
a plurality of support plates, each support plates being connected to a respective bias member;
a plurality of seal segments, each seal segment being connected to a respective support plate, each seal segment having a curved seal face of substantially the same radius as the rotary shaft; and,
the seal segments being made of a fiber reinforced ceramic matrix composite material, the fiber reinforced ceramic matrix composite material includes a pre-ceramic resin in its ceramic state, and fibers.

19. The seal assembly of claim 18, and further comprising:
The pre-ceramic resin is a polymer-derived pre-ceramic resin.

20. The seal assembly of claim 19, and further comprising:
The polymer-derived pre-ceramic resin is one of silicon-carboxyl resin and alumina silicate resin.

21. The seal assembly of claim 18, and further comprising:
The fibers are comprised of one or more of alumina, Nextel 312, Nextel 440, Nextel 510, Nextel 550, silicon nitride, silicon carbide, HPZ, graphite, carbon, and peat.

22. The seal assembly of claim 21, and further comprising:
The fibers being in the form of non-continuous, loose fibers having lengths of about 0.2 to 5.0 inches.

23. The seal assembly of claim 22, and further comprising:
The fibers comprise a volume percent of about 15 to 60 percent.

24. The seal assembly of claim 19, and further comprising:
The seal segments also being made of a filler material, the filler material comprising one of alumina, mullite, silica, silicon carbide, titania, silicon nitride, boron nitride, carbon, magnesium oxide, and boron carbide.

25. The seal assembly of claim 24, and further comprising:
The filler material comprises a volume percent of about 0 to 50 percent.

26. The seal assembly of claim 20, and further comprising:
The fibers are comprised of one or more of alumina, Nextel 312, Nextel 440, Nextel 510, Nextel 550, silicon nitride, silicon carbide, HPZ, graphite, carbon, and peat.

27. The seal assembly of claim 26, and further comprising:
The fibers being in the form of non-continuous, loose fibers having lengths of about 0.2 to 5.0 inches.

28. The seal assembly of claim 27, and further comprising:
The fibers comprise a volume percent of about 15 to 60 percent.

29. The seal assembly of claim 28, and further comprising:
The seal segments also being made of a filler material, the filler material comprising one of alumina, mullite, silica, silicon carbide, titania, silicon nitride, boron nitride, carbon, magnesium oxide, and boron carbide.
